(19) United States
(12) Patent Application Publication
(10) Pub. No.: US 2007/0003920 A1
(43) Pub. Date: Jan. 4, 2007

(54) Immersive video retrospective exhibit

(76) Inventor: Timothy Paul Laun, Brooklyn, NY (US)

Correspondence Address: Timothy Laun, Apt. 4R, 227 Devoe Street, Brooklyn, NY, 11211, US

(21) Appl. No.: 11/105,674

(22) Filed: Apr. 12, 2005

Related U.S. Application Data
(60) Provisional application No. 60/561,619, filed on Apr. 13, 2004.

(51) Int. Cl. H04N 7/00; G09B 25/00

(52) U.S. Cl. 434/428; 348/36

(57) ABSTRACT

A system and method for an Immersive Video Retrospective Exhibit is provided. Included is a circular exhibit space comprised of a plurality of Video Display Terminals (VDT) enclosing a viewing space large enough to accommodate at least 20 people. Each VDT is adapted to display one unit of video content relating to a thematic whole. Furthermore, a wireless audio guide and keypad enable a viewer to select content, particularly audio but not limited to such, from a specific VDT. A domed ceiling which covers the circular exhibit space which is accessed through the floor by ramps, stairs, or elevator. This exhibit is particularly suited to simultaneously show every game in the career of an athlete, and can also be used for other exhibit applications.

### CROSS-REFERENCE TO RELATED APPLICATIONS

The non-provisional patent application for my invention, Immersive Video Retrospective Exhibit, is based on the provisional patent application for 360° Video Retrospective, No. 60/561619, filing date Apr. 13, 2004.

### STATEMENT REGARDING FEDERALLY SPONSORED RESEARCH OR DEVELOPMENT

Not Applicable

### REFERENCE TO SEQUENCE LISTING, A TABLE. OR A COMPUTER PROGRAM LISTING COMPACT DISK APPENDIX

Not Applicable

### BACKGROUND OF THE INVENTION

The impetus for my invention, Immersive Video Retrospective Exhibit, originates from following Brett Favre's career over the past twelve years. Brett Favre is the star quarterback of the Green Bay Packers and will likely be inducted into the Pro Football Hall of Fame. In addition to being a popular, successful, and talented quarterback Favre is legendary for this record of endurance. In thirteen seasons with the Packers, Favre has never missed a game, a feat of consecutive games which is unmatched by another quarterback in the history of football. Such a legacy has the capability to resonate beyond the world of sports—much like the fascination society has with athletes like Babe Ruth, Mohammed Ali, Michael Jordan, and Tiger Woods, all of whom have transcended their sport to become cultural icons. The exceptional nature of Favre's career, and his continuous game streak, is the foundation of my invention, a type of exhibit which specifically relates to the field of sports entertainment.

Favre's career has unfolded during in an era of satellite television broadcasting and the Internet. This means it has been entirely possible for fans to watch every game of Favre's career. I myself have seen every game despite the fact I've been living in New York City (where the local broadcast doesn't typically show Green Bay games) for the last eight years. The experience of living in an era where it is possible to track an event anywhere in the world through television (in this case, the entire career of an athlete) regardless of one's own location has informed my invention.

The sports industry is a very popular spectacle within our society. This is reflected by stadium attendance, television ratings, and the enormous amount of revenue the industry generates. Even a Major League Baseball team like the Milwaukee Brewers, a perennial loser for more than two decades, managed to draw over two million spectators in 2004. Sports, obviously, is a big business. And furthermore, the influence of the sports industry is such that it extends into virtually all other sectors of culture including advertising, movies, the music industry, headline news, education, and government. Whether it's a Nike commercial featuring Michael Jordan executing a slam dunk in slow motion, the Boston Red Sox winning the championship for the first time in 86 years, a political campaign to bring the Olympics to New York City, public referendums to build stadiums with tax payer money, baseball players testifying about steroid abuse in front of Congress, or a shocking fight among players and fans during a Detroit Piston's game, sports, as much as any other cultural category, is deeply integrated into our social fabric, and the public deeply cares about this subject.

Although sports can generally be reduced to a game that is played on a field between two teams (or two athletes) the industry is such that its audience expects, and is desirous in many cases, to consume more than just the game. For example, during the last Super Bowl the Fox television network broadcasted fifteen hours of material—game analysis, historical documentaries, and human interest stories—before the actual game was played. This is a normal condition of the sports industry, the need to fill a void surrounding the game with content such as commercials, analysis, post game shows, sports radio talk shows, etc.

The need to fill this void surrounding the game manifests itself in different ways and for different reasons. Sports fans not only want to see the game, but also including museum and hall of fame exhibits. For example, the Green Bay Packers recently renovated their stadium, Lambeau Field, to include a spectacular Hall of Fame museum. Not only can fans support the team through buying tickets and attending the game, they can visit the stadium during times when there is no game, and experience a museum exhibit about present and past players, and the history of the team. This benefits the organization because they are able to generate revenue throughout the entire year, not just when games are occurring. With this revenue the organization has more money to spend on better players, and the fans are more likely to be satisfied with the team and continue their support. Ultimately, the sports organization is more sound.

In recent years, sports franchises have considered such ways to increase revenue in order to maximize profit, increase chances of success to stay competitive with other teams, and to finance stadium projects. For example, The Green Bay Packers were able to convince the public to support a modest increase in the state sales tax in order to help finance a 200 million dollar renovation of the stadium. The Packers organization argued that they needed to renovate the stadium in such a way that it would stay fiscally competitive with other teams. They argued this goal could not be achieved through the existing facilities, and a new facility would offer multiple ways of generating income the existing stadium could not. The renovation project included an aesthetically pleasing atrium open to the public year around, several Packers-themed food restaurants and pubs, a sports memorabilia shop, and the Hall of Fame museum exhibit. All of the above attractions were conceived as a way of generating revenue, and they draw thousands of visitors annually.

The above strategy to generate additional revenue is part of the business plan of every sports franchise. The problem is, once the novelty of such an attraction wears thin, the organization must develop new ones to continue generating revenue in order to stay competitive with other teams and satisfy its fans. Furthermore, if an organization were to develop a unique attraction, this could increase interest in the team and therefore generate more revenue. My invention is a type of exhibit that can satisfy these needs and interests.

Circular, or panoramic, exhibition spaces have been proposed—for example in U.S. Pat. No. 6,669,346 to Metcalf (2003). This invention provides a panoramic experience for a large audience based on the use of a digital projection on a single continuous screen. Such an invention, as is the case with panoramic images, lends itself to the exhibition of continuous, illusionistic imagery such as photographs, landscapes, or other computer generated fields such as video games. In the case of my invention, the exhibit emphasizes the physical display (the VDTs themselves) of individual units of video (or information) which make up a thematic whole. The physical presence of the VDTs literally are building blocks in an immersive experience for the audience.

Accordingly, besides the objects and advantages of the Immersive Video Retrospective Exhibit described in my above patent, several objects and advantages of the present invention are:
(a) To provide a novel museum exhibit experience which is different than prior examples. This is achieved primarily through building an immersive space, which physically defines the scope of a subject as well as displaying different forms of content. In short, the present invention would create a physical/emotional/aesthetic experience while at the same time offering a critical dissemination of information.
(b) To provide the complete archive of a subject, in this case the whole career of an athlete, instead of highlights or edited selections, which is typically the case.
(c) To provide a non-hierarchical exhibit
(d) In a typical sports museum or hall of fame we generally see objects, memorabilia, and video highlights of our favorite team. In many instances, we are separated from these items by glass barriers and vitrines. We walk around looking at these different items, they all tell part of a story-but not the whole story. My invention provides an immersive and more interactive experience different from the typical sports museum or hall of fame. Instead of looking at an exhibit, we are within the exhibit. Instead of showing the obvious highlights we normally see in museums or on television, my invention will show everything, all of the footage available from a particular era.

### BRIEF SUMMARY OF THE INVENTION

According to the invention, the exhibit (although somewhat variable in size depending on location and budget) would be most effective on the scale of a gymnasium or museum gallery like the ones at the Natural History Museum in New York City—several thousand square feet with 16-30 foot ceilings. The installation would accommodate large public gatherings of at least 20 people in compliance with ADA requirements. Using Brett Favre as the subject, the exhibit would require between 220 and 250 television screens—one for each game of his career (which is not complete at the time of publication). The VDTs are arranged in a circular format creating an enclosed viewing space which surrounds the audience. Although the specific brand or style of VDT is not critical, it is important the screens be large enough for viewers to see them at reasonable distances, and the aspect ratio should match the video content. The physical aesthetics of the televisions should not interfere with the video content therefore a simply designed television of neutral color is appropriate. Additionally, the general architecture of the exhibit should be considered in order to increase the immersive nature of the experience for the audience. This can be achieved in part by providing a domed ceiling which completely covers the exhibit space in order to reinforce the gestalt of the total architecture.

### BRIEF DESCRIPTION OF THE SEVERAL VIEWS OF THE DRAWING

FIG. 1 shows an overall above perspective view of the invention.

FIG. 2 shows an interior view of the invention with audience using wireless headphones and keypad.

FIGS. 3A to 3D show the circular configuration of the exhibit from above and how the scale of the installation is relative to the size and quantity of VDTs. FIG. 3A to 3B represent an installation of 250 VDTs each 40 inches wide and stacked 5 high vertically, which creates an exhibition space with a diameter of 60 feet. FIG. 3C to 3D represent an installation of 125 VDTs each 160 inches wide and stacked 5 high vertically, which creates an exhibition space with a diameter of 120 feet.

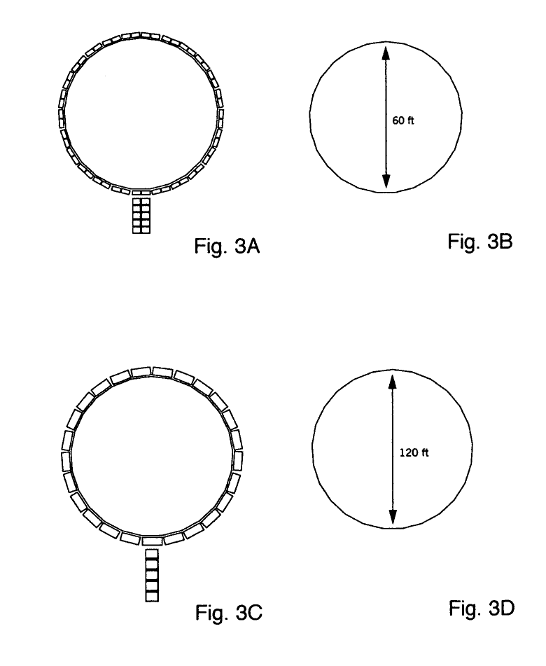

FIG. 4A and 4B shows the preferred entrance to the exhibit through a passageway in the floor. FIG. 4A shows a top view representing passageways through the floor of the exhibit. FIG. 4B shows a side view representing ramps ascending to the floor of the exhibit. FIG. 4C shows an alternative way to enter the exhibit. VDTs can be removed to make entranceways from the side. If the number of units of video content of the subject calls for an odd number of television screens, this option can used to aesthetically distribute the VDTs, while providing entrances to the exhibit.

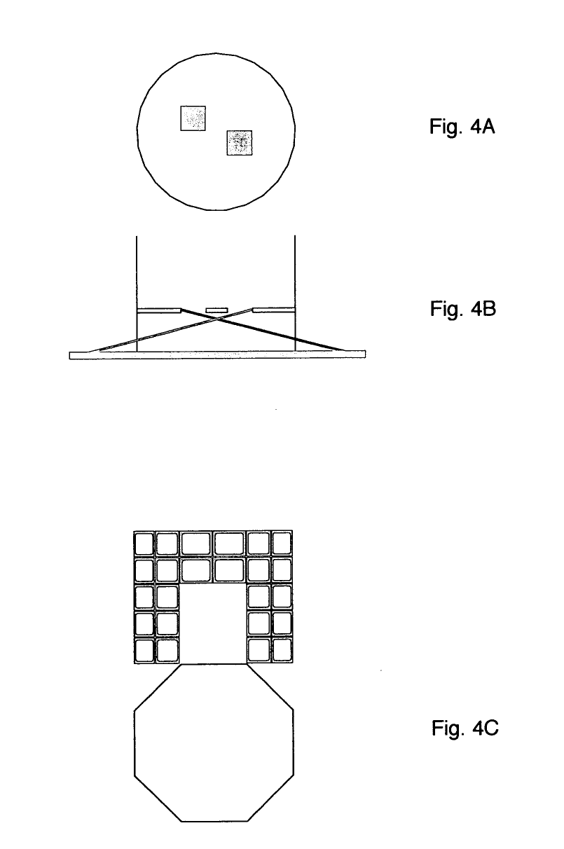

### DETAILED DESCRIPTION OF THE INVENTION

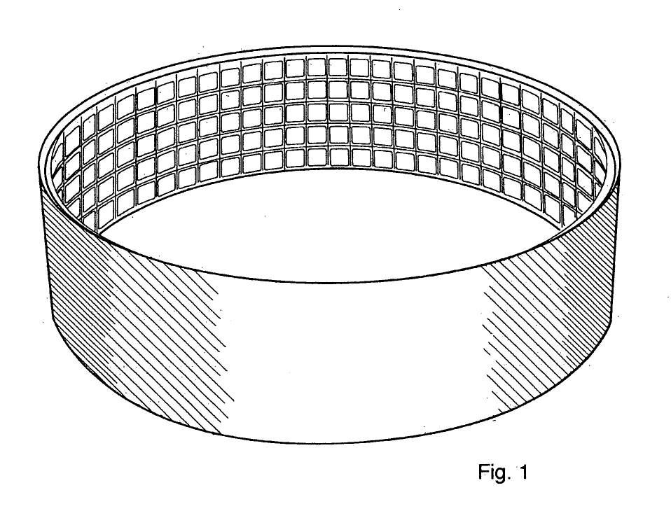

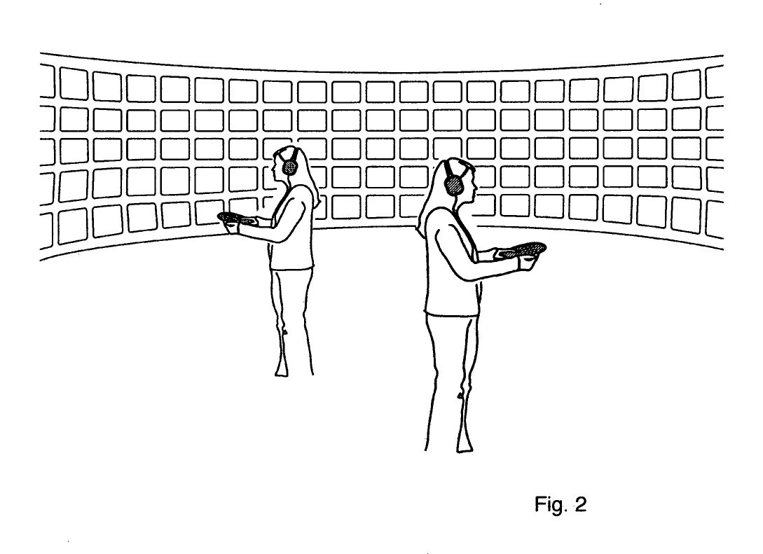

A preferred embodiment of the invention is represented in FIG. 1 and FIG. 2. The structure of the environment is a circular bank of television screens arranged in 360 degrees, which is capable of surrounding a large audience of at least 20 people. Since the number of televisions is dependent on the units of video content (in Favre's case, the number of games in his career), the configuration of television screens is adjusted to fit the subject. The main variables that determine the size of the installation are the quantity and size of the television screens. The height of the installation—the number of televisions stacked vertically—will determine the diameter. By decreasing the number of televisions stacked vertically, the diameter of the space is made bigger. These relationships should be understood in order to choose the proper television size and configuration to fit a given space. Furthermore, the VDTs should be mounted on industrial shelves or scaffolding configured to provide a circular exhibit space which surrounds an audience.

The primary content of the invention is units of video documentation of the subject—in Favre's case, each game of his career. The video content is digital and should be stored on a computer server that is connected to and displayed on the individual VDTs.

Each unit of video content will have it's own audio. An audio-guide headset will be made available to allow an individual to choose the audio of a specific television screen. In the case of the Favre installation, a viewer would type the numbers 1-2-3 on their audio guide and get the audio for the 123rd game of Favre's career. The game number should be listed on the VDT or on the floor in way that aesthetically blends with the installation. Audio technology of this type is common in museums and tourist attractions such as Edinburgh castle in Scotland, and the Metropolitan Museum of Art in New York City. In addition to audio for each television, depending on the subject and specific installation, the audio guide can provide multiple layers of additional information about what the participant is watching. If one chooses not use the audio guide, the installation is experienced as a silent—a quiet but visually powerful experience.

Additional embodiments are possible. Although the ideal and most basic embodiment of the exhibit is a full 360-degree enclosure of the audience (FIG. 1), the exhibit can be presented in enough of a circular or arced space to at least partially surround the audience. If it's impossible to create a 360° enclosed exhibit, the preferred amount of closure of the space is 240°-360°, however, any degree of arced or circular space would provide some degree of the desired effect. The totality of a particular subject could be provided in a non-circular configuration of VDTs as well.

Although this exhibit is particularly suited for the career of an athlete, several alternate embodiments exist. This invention would suit multiple subjects in areas such as education, history, government, and entertainment where there are many units of video content comprising a thematic whole.

Operation of the invention goes as follows. The audience ascends a staircase, ramp, or elevator and enters the exhibit through a passageway in the floor and is immersed in a configuration of televisions, stacked 16-30 feet high, which creates a circular space large enough to accommodate a crowd of at least 20 people. The installation of over 200 VDTs are showing units of video content which relate to thematic whole and may be experienced in silence or with audio content from each of the VDTs available through a wireless headset and keypad. The video content of the VDTs is the complete original broadcasts of every game of an athlete, including commercials—one game per screen. Because the exhibit includes every second of every game, rather than simply highlights or only the best games, the exhibit is a time capsule of popular culture and sports history from 1991 to the present. Through the inclusion of less obvious video content such as commercials the exhibit reflects the passage of time, evidenced by changing fads and fashions while Favre's participation in the sport is constant.

The reader will see that the Immersive Video Retrospective Exhibit is an invention uniquely suited to meet the needs of the Sports Industry and its fans. Unlike traditional museum exhibits which provide objects and information to be considered, my invention provides an immersive and interactive environment which offers a full scope of information and content.

1. A circular exhibit comprised of a plurality of individual Video Display Terminals (VDTs) enclosing a viewing space in which each VDT displays one unit of video content related to a thematic whole.

2. A circular exhibit space as defined in claim 1 which includes:
A.) A wireless audio guide and keypad enables a viewer to select content from a specific VDT.
B.) A domed ceiling which covers the circular exhibit space in order to strengthen the gestalt of the total architecture of the exhibit.
C.) Labels to identify video content being shown on VDTs.
D.) Ramps, stairs, or elevators to enter exhibit space through floor.
